(19) United States
(12) Patent Application Publication
(10) Pub. No.: US 2007/0108127 A1
(43) Pub. Date: May 17, 2007

(54) Treatment of iron sulphide deposits

(76) Inventors: Robert Eric Talbot, Cannock (GB); Christopher Raymond Jones, Cheslyn Hay (GB); Jason Grech, Worcester (GB)

Correspondence Address: Jean-Louis Seugnet;Rhodia Inc-Legal Department, 8 Cedar Brook Drive, Cranbury, NJ, 08512-7500, US

(21) Appl. No.: 10/571,329

(22) PCT Filed: Sep. 10, 2004
(86) PCT No.: PCT/GB04/03856

§ 371 Date: Nov. 13, 2006

(30) Foreign Application Priority Data
Sep. 11, 2003 (GB) 0321276.8

(51) Int. Cl. C02F 1/00; C02F 5/08

(52) U.S. Cl. 210/639; 210/696; 252/175

(57) ABSTRACT

The present invention relates to a method of treating an aqueous system containing or in contact with metal sulphide scale. The method comprises adding to said system, separately or together, sufficient of a synergistic mixture comprising a THP⁺ salt, an aqueous solution of a strong acid (and optionally a source of nitrogen) to provide a solution containing from 0.1% to 30% by weight of the THP⁺ salt at a pH of less than about 1.0. The scale is contacted with said solution, (thereby dissolving at least part of said scale in said solution) and the dissolved scale is withdrawn from the system.

The present invention relates to a method of preventing or alleviating the problems which are commonly associated with deposits of iron sulphide.

Iron sulphide deposits are a major source of economic loss in the oil industry. These deposits are mainly the result of reaction between hydrogen sulphide, often formed by sulphate reducing bacteria, and ferrous metal oilfield equipment and/or iron compounds in the formation. They obstruct the flow of oil through wells, in the adjacent strata and also in pipelines and in processing and refinery plant. Iron sulphide particles also tend to stabilise oil-water emulsions which often form, especially during secondary oil recovery, and present major problems to oil producers. The simplest way to dissolve a deposit of iron sulphide is by contact with a solution of a strong acid. However, one of the problems of using acid is that, as the acid is used and the pH rises, the solution will no longer dissolve iron sulphide. It will then also start to deposit some of the iron dissolved in it, causing new obstructions.

It is known that tris(hydroxymethyl)phosphine (referred to herein as THP) is capable of solublising iron sulphide by forming a bright red water-soluble complex. THP is believed to be formed in oil wells treated with tetrakis(hydroxymethyl)phosphonium salts (THP⁺ salts). THP⁺ salts, especially the sulphate (THPS) are commonly added to oil wells as biocides. THP⁺ salts are highly effective at killing the sulphate-reducing bacteria, whose activity may be responsible for the original formation of the iron sulphide deposits.

The effectiveness of THP as a solubilising agent for iron sulphide varies considerably from well to well. It has been shown that this is because the complex with iron sulphide requires the presence of a nitrogen source, usually ammonium ions, the levels of which vary in different wells. It is also known that THP is critical to the formation of the complex.

At application concentrations, e.g. below 3%, THP⁺ salts are stable under acidic conditions, in the absence of air or oxidising agents. At pH above 3 and in the absence of oxidising agents, they are gradually converted to THP. Conversion is rapid and substantially complete between pH of about 4 and 6. Above pH 7, or in the presence of oxidising agents, THP⁺ salts or THP are converted to tris(hydroxymethyl)phosphine oxide (THPO), conversion being rapid and substantially complete at pH above about 10 to 12. THPO is not effective as a complexant for iron sulphide.

Strong acids are often used for well stimulation. Acid is pumped into the wellbore to remove near-well formation damage and other damaging substances. This procedure enhances production by improving the reservoir rock permeability and increasing the effective well radius. The acid will also dissolve ferric containing corrosion deposits which can react with the oil to form insoluble solids. These ferric ions are often reduced to ferrous ions by the use of reducing agents in the acid formulation. The ferrous ions do not react with the oil and are acid soluble. They can also react with hydrogen sulphide to produce iron sulphide which is also soluble in the acid. The problem arises when the acid formulation becomes spent i.e. its pH starts to rise. Iron sulphides become insoluble at a pH above about 1.2. Therefore, as this pH is reached, the iron sulphides will no longer be dissolved. Furthermore, iron already dissolved in the acid can start to precipitate back out of solution, blocking the formation rock.

We have now discovered that THP⁺ salts and nitrogen sources such as ammonium are effective at preventing and removing iron sulphide scale, when used in combination with a solution of a strong acid. As previously stated, THP is the species required for iron complex formation, but THP is not usually formed at a pH below about 3. This result is therefore unexpected.

It is an aim of the present invention to prolong the iron sulphide dissolving properties of the acid solution. That is, as the acid solution becomes spent, the mechanism for iron sulphide dissolution will change form acid dissolution to complexation by THP.

The present invention therefore provides a method of treating an aqueous system containing or in contact with metal sulphide scale, which method comprises adding to said system, separately or together, sufficient of a synergistic mixture comprising a THP⁺ salt, an aqueous solution of a strong acid (and optionally a source of nitrogen) to provide a solution containing from 0.1% to 30% by weight of the THP⁺ salt at a pH of less than about 1.0, contacting said scale with said solution, (thereby dissolving at least part of said scale in said solution) and withdrawing said dissolved scale from the system.

The present invention also provides a synergistic mixture for use in the method aforesaid, said mixture comprising between 0.1% and 50% by weight of the strong acid, between 0.1% and 30% by weight of the THP⁺ salt and between 0.1% and 10% by weight of the optional nitrogen source.

The present invention further provides a formulation comprising the synergistic mixture aforesaid and one or more additional water-treatment products selected from anionic surfactants, cationic surfactants, amphoteric surfactants, non-ionic surfactants, wetting agents, biocides, dispersants, demulsifiers, antifoams, solvents, scale inhibitors, corrosion inhibitors, gas hydrate inhibitors, asphaltene inhibitors, naphthenate inhibitors, oxygen scavengers and flocculants.

Finally, the present invention provides the use of a synergistic mixture of a THP⁺ salt, together with an aqueous solution of a strong acid (and optionally a source of nitrogen) to inhibit, reduce, dissolve or disperse deposits of metal sulphide in an aqueous system, according to the method aforesaid.

The metal sulphide may comprise, for example, an iron sulphide. Alternatively, the metal sulphide may be lead sulphide or zinc sulphide or a combination any two or more of iron or lead or zinc sulphides. The iron sulphide may be troilite (FeS) or pyrite (FeS₂). Alternatively the iron sulphide may be mackinawite (Fe₉S₂) or pyrrhotite (Fe₇S₂).

The strong acid may be a mineral acid (e.g. sulphuric acid, phosphoric acid, nitric acid or hydrogen halide) or an organic acid (e.g. formic acid or acetic acid). It preferably comprises an aqueous solution of hydrogen chloride.

Suitably, the THP⁺ salt is tetrakis(hydroxymethyl)phosphonium sulphate (THPS). Alternatively, the corresponding chloride, bromide, iodide, phosphate, borate or carboxylate may be used.

Suitably, the source of nitrogen may be ammonia gas, an aqueous solution of ammonia or an amine e.g. (methylamine or ethylamine). Nitrogen may alternatively be provided by other nitrogen-containing compounds such as amine-phosphonates, e.g. diethylenetriaminepentakis(methylenephosphonic acid). The nitrogen source is most preferably a water-soluble ammonium salt such as ammonium chloride or ammonium sulphate. In accordance with the present invention, THP⁺ can be used in conjunction with an acid, without the presence of a nitrogen source.

The acid solution, THP⁺ salt and optional nitrogen source may be formulated together prior to addition to the aqueous system. Alternatively, they may be added to the system individually (but at the same time). The acid component may preferably constitute between 0.1 and 50% of the synergistic mixture. The THP⁺ salt may preferably constitute 0.1-30% and the optional nitrogen source may preferably constitute 0.1-10% of the synergistic mixture.

Formulations for use according to our invention may also include other water treatment products such as anionic, cationic, amphoteric and non-ionic surfactants and wetting agents. The formulation may additionally contain biocides, (for example, formaldehyde or glutaraldehyde) dispersants, demulsifiers, antifoams, solvents, scale inhibitors, corrosion inhibitors, gas hydrate inhibitors, asphaltene inhibitors, naphthenate inhibitors, oxygen scavengers and/or flocculants.

Scale or corrosion inhibitors which may be added to the water to be treated in conjunction with synergistic mixture of the present invention include phosphonates, such as 1-hydroxyethane-1,1-diphosphonate, polymaleates, polyacrylates, polymethacrylates, polyphosphates, phosphate esters, soluble zinc salts, nitrates, sulphites, benzoates, tannin, ligninsulphonates, benzotriazoles and mercaptobenzothiazoles, amines, imidazolines, quaternary ammonium compounds, polyaspartates, resins and phosphate esters, all added in conventional amounts. The scale and/or corrosion inhibitors may be added to the water separately from or in association with the phosphonium compound and surfactant. There may be added to the water to be treated oxygen scavengers, flocculants such as polyacrylamide dispersants, antifoams such as acetylenic diols, silicones or polyethoxylated antifoams, aluminium stearate or other biocides such as acrolein, brominated biocides such as BRONOPOL® or DBNPA, tin compounds or isothiazolones.

Formulations of the invention may also comprise non-surfactant biopenetrants including any of those described in WO99/33345.

When THP is added in the form of a THP⁺ salt the latter may comprise any counterion which is compatible with the system. Preferred are sulphate, chloride and phosphate, but any other convenient anion which provides a water soluble salt may be used.

The invention will be illustrated by the following examples in which all proportions are by weight of active ingredient unless otherwise stated:

### EXAMPLE

Iron sulphide dissolution tests were prepared according to the following: THPS (20%), ammonium chloride (1%) and iron sulphide field scale (3 g) were accurately weighed. The pH was adjusted to the required value by the addition of hydrochloric acid and the mixtures were stirred overnight in a water bath at 50° C. The solution was then filtered and weight loss calculated. Iron levels in the resulting solution were measured using a colourimetric technique.

| | Start | | Iron content of | Weight loss of |
|---|---|---|---|---|
| Dissolver | pH | Final pH | solution (ppm) | scale (%)* |
| THPS/NH₄Cl | 3.46 | 1.92 | 7128 | 69 |
| THPS/NH₄Cl | 2.0 | 1.94 | 6956 | 70 |
| THPS/NH₄Cl | 1.2 | 1.59 | 6324 | 78 |
| HCl | 2.0 | 6.15 | 6 | 29 |
| (comparison) | | | | |
| HCl | 1.2 | 4.62 | 740 | 38 |
| (comparison) | | | | |

*A “blank” experiment showed that a weight loss of 27% can be expected from the scale merely by removal of the oil associated with the scale.

1-25. (canceled)

26. A method of treating an aqueous system containing or in contact with metal sulphide scale, comprises the steps of:
a) adding to said system, separately or together, sufficient of a synergistic mixture comprising a THP⁺ salt, an aqueous solution of a strong acid (and optionally a source of nitrogen) to provide a solution containing from 0.1% to 30% by weight of the THP⁺ salt at a pH of less than about 1.0,
b) contacting said scale with said solution, thereby dissolving at least part of said scale in said solution, and
c) withdrawing said dissolved scale from the system.

27. The method according to claim 26, wherein the metal sulphide comprises an iron sulphide.

28. The method according to claim 27, wherein the iron sulphide is troilite (FeS), pyrite (FeS₂), mackinawite (Fe₉S₂) or pyrrhotite (Fe₇S₂).

29. The method according to claim 26, wherein the metal sulphide is lead sulphide or zinc sulphide.

30. The method according to claim 26, wherein the metal sulphide comprises any two or more of iron sulphide, lead sulphide and zinc sulphide.

31. The method according to claim 26, wherein the strong acid is a mineral acid.

32. The method according to claim 31, wherein the strong acid is sulphuric acid, phosphoric acid, nitric acid or a hydrogen halide.

33. The method according to claim 32, wherein the strong acid comprises an aqueous solution of hydrogen chloride.

34. The method according to claim 26, wherein the strong acid is an organic acid.

35. The method according to claim 34, wherein the strong acid is formic acid or acetic acid.

36. The method according to claim 26, wherein the THP⁺ salt is tetrakis(hydroxymethyl)phosphonium sulphate (THPS).

37. The method according to claim 26, wherein the THP⁺ salt is tetrakis(hydroxymethyl)phosphonium chloride, bromide, iodide, phosphate, borate or carboxylate.

38. The method according to claim 26, wherein the nitrogen source comprises ammonia gas or an aqueous solution of ammonia.

39. The method according to claim 26, wherein the nitrogen source comprises an amine, optionally methylamine or ethylamine.

40. The method according to claim 26, wherein the nitrogen source comprises an amine-phosphonate.

41. The method according to claim 40, wherein the phosphonate is diethylenetriaminepertakis(methylenephosphonic acid).

42. The method according to claim 26, wherein the nitrogen source is a water-soluble ammonium salt.

43. The method according to claim 42, wherein the nitrogen source is ammonium chloride or ammonium sulphate.

43. The method according to claim 26, wherein the acid solution, the THP⁺ salt and the optional nitrogen source are formulated together prior to addition to the aqueous system.

44. The method according to claim 26, wherein the acid solution, the THP⁺ salt and the optional nitrogen source are added to the aqueous system individually but at the same time.

45. A formulation comprising:
a synergistic mixture comprising between 0.1% and 50% by weight of the strong acid, between 0.1% and 30% by weight of the THP⁺ salt and between 0.1% and 10% by weight of the optional nitrogen source, and
one or more additional water-treatment products selected from the group consisting of anionic surfactants, cationic surfactants, amphoteric surfactants, non-ionic surfactants, wetting agents, biocides, dispersants, demulsifiers, antifoams, solvents, scale inhibitors, corrosion inhibitors, gas hydrate inhibitors, asphaltene inhibitors, naphthenate inhibitors, oxygen scavengers and flocculants.
